(19) United States
(12) Patent Application Publication
(10) Pub. No.: US 2006/0254405 A1
(43) Pub. Date: Nov. 16, 2006

(54) MUSICAL INSTRUMENT STRING AND METHOD OF FABRICATION

(76) Inventor: William Allen Bergman, Grand ledge, MI (US)

Correspondence Address: PAPARELLA & ASSOCIATES, PLC, 930 N. WASHINGTON AVE., LANSING, MI, 48906, US

(21) Appl. No.: 11/382,750

(22) Filed: May 11, 2006

Related U.S. Application Data
(60) Provisional application No. 60/681,042, filed on May 16, 2005.

(51) Int. Cl. G10D 3/14; G10D 3/12; G10D 3/10

(52) U.S. Cl. 84/297 R

(57) ABSTRACT

A string for a musical instrument includes an elongated string having a first and second end, and a playable section disposed therebetween. The string is fabricated at least partially from a plastic, wherein the plastic includes metallic particles disposed therein. Further, the metallic particles are distributed within the plastic such that the mass per unit length is generally uniform along the playable section of the string. As such, the string is suitable for use as a musical instrument string.

This application claims the benefit of the filing date of U.S. provisional application Ser. No. 60/681,042 entitled “POWDERED METAL CORE PLASTIC MUSICAL INSTRUMENT STRINGS” which was filed on May 16, 2005 and which is incorporated herein by reference.

### BACKGROUND OF THE INVENTION

The present invention pertains to musical strings, and more specifically to plastic musical strings and a method of manufacturing thereof.

There are a multitude of different types of musical strings which are available to today's musicians. In broader terms however, there are generally two types of strings. Namely straight or non-wound strings, and wound strings. Non-wound strings for example, typically comprise a straight (i.e., non-wound) string which is fabricated from either metal, or plastic, and are generally used for higher pitched notes. Wound metal or plastic strings on the other hand usually comprise a wrapped metal or plastic winding, over a core comprising either a solid string or a bundle of strings fabricated from metal, plastic, or other textile, and are generally used for lower pitch notes. Wound strings rely on the additional string mass per unit length supplied by the spiral wrap to supply lower pitched notes at an acceptable string tension.

Many stringed musical instruments require that a musicians fingers contact at least a portion of the string. For example, a guitar requires that the musician use their fingers to determine what notes are used (termed fingering), and while non-wound strings can be easily wiped of dirt and oil after use, wound strings tend to become contaminated with dirt, skin oils, perspiration, and the like. Consequently, this contamination has adverse tonal effects on these wound strings. Presently wound strings that lose their tonal qualities must be removed from the instrument and either cleaned or replaced. This process is burdensome, time consuming, and expensive, especially for musicians who play frequently and/or care about tonal quality.

Another problem is encountered with strings requiring fingering along a fingering board (e.g., a guitar neck). In these circumstances, a substantial amount of pressure must be applied by the musician against the fingering board in order to produce the different musical notes. Accomplished musicians normally develop calluses on their fingers and as such, are able to play the instrument relatively pain free. However, beginning musicians have not developed these calluses and therefore, the pain associated with playing the instrument can be severe and as such, can be discouraging for the beginning musical student.

Still another problem with conventional wound strings is that the action of quickly fingering across the strings often generates unwanted noises. For instance, it is common to hear a “squeak” from wound strings on a guitar as a musicians fingers rapidly move across the guitar strings on the neck. In order to avoid such squeaks, the musician must make a concerted effort to completely separate their fingers vertically from the strings when repositioning them on the neck. However, this repositioning action slows the musician's note changes and further increases fatigue. And, even the most accomplished virtuosos are not completely successful in avoiding these squeaks which detract from the overall performance. Yet another problem is that the helical grooves formed between each turn of the outer winding cause's excessive fret and neck wear as the string surface is pressed into engagement therewith. As such, these windings can fray at the fret locations causing the strings to be ruined; and the core within these wound strings to break along the bridge.

The tonal effect and quality of a string is determined by the characteristics of the string itself, for example, length and diameter. As mentioned above, wound strings are utilized for the larger mass that is required for lower notes, as opposed to their higher note non-wound counterparts. In addition to the length and diameter of the string involved, the tonal qualities of the string are also dependent upon a number of other factors. These include the particular mechanical properties of the material(s) comprising the string, such as ductility, tensile strength, elasticity and density per unit length. Conventional vibratory strings used on musical instruments are typically made of materials having a high elastic modulus such as carbon steel wire, stainless steel wire, phosphor bronze wire, synthetic resin, sheep gut, etc. For pianos and guitars, often a carbon steel wire core having a small diameter will be wound with an annealed copper wire or other precious or semi-precious metal in order to change the density per unit length of the string,

Accordingly, a need exists for novel systems and methods which have, among other advantages, the benefit of avoiding unpleasant squeaking, allowing the adjustment of string diameter for playing comfort, rather than for only pitch and tension; avoiding fraying of the metal windings in traditional strings; and avoiding string breaks along the bridge such as in wound strings which do not have sufficient core strength. Therefore, a musical string that solves the aforementioned disadvantages and having the aforementioned advantages is desired.

### SUMMARY OF THE PRESENT INVENTION

The aforementioned drawbacks and disadvantages of these former musical strings have been identified and a solution is set forth herein by the inventive musical string which includes, a string for a musical instrument comprising an elongated string having a first and second end, and a playable section disposed therebetween. The string is fabricated at least partially from a plastic, wherein the plastic includes metallic particles disposed therein. Further, the metallic particles are distributed within the plastic such that the mass per unit length is generally uniform along the playable section of the string. As such, the string is suitable for use as a musical instrument string.

Another aspect of the present invention includes a string for a musical instrument comprising an elongated string having a first and second end, and a playable section disposed therebetween. The string is fabricated entirely from a plastic, wherein the plastic includes metallic particles disposed generally uniformly therein. Further, the metallic particles are distributed within the plastic such that the mass per unit length is generally uniform along the playable section of the string. As such, the string is suitable for use as a musical instrument string.

In another aspect of the present invention, a method of manufacturing a string for a musical instrument includes: providing one or more plastics; providing a plurality of metallic particles, the plurality of metallic particles comprising one or more metals; blending the one or more plastics and the plurality of metallic particles; forming a single elongated string, whereby the metallic particles are distributed within the one or more plastics such that the mass per unit length is generally uniform along a playable section of the string.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. The music string of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practioners in the art who are not familiar with the patent or legal terms of phraseology, to learn quickly from a cursory inspection the nature and essences of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the music string of the present disclosure, its advantages and the specific objects attained by its uses, reference should be made to the accompanying drawings and descriptive matter in which there are illustrated and described the preferred embodiments of the invention.

While embodiments of the music string are herein illustrated and described, it is to be appreciated that various changes, rearrangements and modifications maybe made therein, without departing from the scope of the invention as defined by the claims.

### BRIEF DESCRIPTION OF THE DRAWINGS

FIG. 1 is a partial front view representing a music string of the prior art;

FIG. 2 is a partial front sectional view of the prior art music string of FIG. 1 taken along line II-II;

FIG. 3 is a partial front view of a music string according to an embodiment of the present invention;

FIG. 4 is a cross sectioned view, taken along line IV-IV of FIG. 3, of the music string of FIG. 3;

FIG. 5 is a cross sectioned view of a music string according to another embodiment of the present invention.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

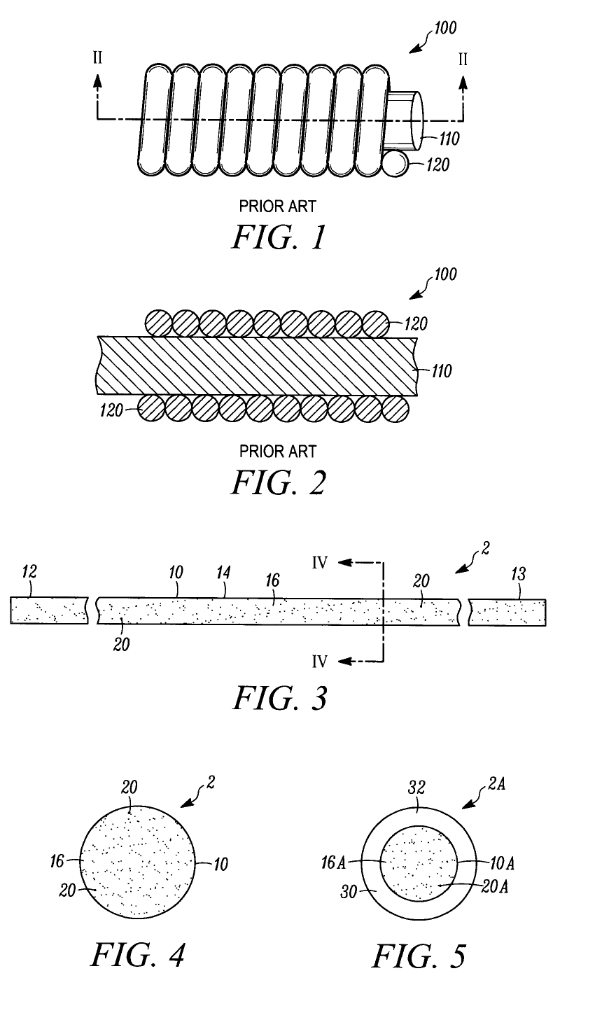

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term plastic is meant to be used and defined in its general and ordinary sense. That is to say that the term plastic refers to a range of synthetic or semi-synthetic polymerization products, and may contain other substances to improve performance or economics. The term is meant to include natural and man-made polymers. Plastics are designed with immense variation in properties such as heat tolerance, hardness, resiliency and many others. Of course, this is not meant to be limiting in any manner.

As used herein, the term metal (i.e., as in metal particles, metal powder) is meant to be used and defined in its general and ordinary sense. That is to say that metal generally refers to any of several chemical elements that are typically shiny solids that conduct heat or electricity and can be formed into sheets and the like. A more scientific definition of metal refers to elements that readily form ions (cations) and have metallic bonds. Metals are sometimes described as a lattice of positive ions (cations) surrounded by a cloud of delocalized electrons. A more modern definition of metals is that they have overlapping conductance bands and valence bands in their electronic structure. This definition opens up the category to include metallic polymers and other organic metals, and synthetic materials. Metal alloys may also be used. Of course, this is not meant to be limiting in any manner.

Generally, musical instrument strings are tuned to a specific pitch through the variation of one or more of three main factors: 1) the length of the string; 2) the tension of the string; and 3) the mass per unit length of the string. For a particular instrument, the length of each string is typically fixed, and the tension of each string is constrained for a number of reasons, including the structural strength of the instrument and numerous factors related to playability. As such, the mass per unit length of the string is left as the main variable for controlling for the pitch of the string.

Treble, or high pitch strings, are typically a single filament of either: 1) metal, typically steel piano wire; or 2) plastic, typically nylon or similar materials. The diameter of the string is selected to provide the appropriate mass per unit length (MPUL). As the strings diameter is increased, the MPUL increases creating the next, lower pitch string (usually of the same material). Successively lower pitch strings are then created by increasing the strings diameter. However, the diameter eventually becomes so large that the string itself becomes inflexible, so as to cause numerous problems as are generally known in the art. This problem has heretofore been solved by using a small diameter (i.e., more flexible) solid core of wire or nylon, or a bundled core of the like, and then winding or wrapping a metal wire around the core along the entire length of the string. However, this exterior metal winding and thin interior core can cause numerous problems.

One such problem of wound metal strings is that the movement of the musician's fingers (or other accessory) along the strings during play causes loud and distracting “squeaks.” These noises are heard as the musician's fingers rub the ridges which are created by the winding itself. A second problem is that the repetitive pressing of the strings on the frets soon causes the fine metal windings to wear through and ruin the string. Another problem is that the strings may break under tension due to the central filament (or filaments) being of a small diameter and therefore, relatively weak.

Furthermore, a problem exists for guitars with plastic based strings. The “G” string is the largest diameter string which can be accommodated by a single monofilament. This string requires a mass per unit length that is too small for a metal wound string. However, the “G” string, when fabricated from a solid plastic, is so rigid the string cannot flex properly near the supports at each end. As a result, the string behaves as if it were actually shorter than it is. Efforts have been made to compensate for this by utilizing small adjustments to the supports at each end, however, the intonation remains imperfect.

Accordingly, a need exists for a music string that can be fabricated with a high enough MPUL for lower tonal strings without utilizing winding and has, among other advantages, the ability to eliminate the noises associated with finger movement on standard wound strings, increase strength, and is easy to use. Therefore, a music string that solves the aforementioned disadvantages and having the aforementioned advantages is disclosed herein.

A prior art string 100 is disclosed in FIGS. 1-2, which includes a central core string 110 surrounded by, or wrapped by, a wound string 120, as is known in the art. For simplicity in these prior art drawings, the core 110 is depicted a single core element. However, these prior art cores may also comprise multiple single core elements bundled together. The disadvantages and drawbacks of the prior art are overcome through the musical string 2 of the present invention, wherein one preferred embodiment is disclosed in FIGS. 3-4, comprising a string 10 including metal particles 20. Referring now to FIG. 3, there is shown a string for a musical instrument 2, comprising an elongated string 10 having a first and second ends, 12 and 13, respectively, and a playable section 14 disposed therebetween. String 10 is fabricated at least partially from a plastic material 16, wherein plastic material 16 includes metallic particles 20 disposed therein. Metallic particles 20 are distributed within plastic 16 such that the mass per unit length of string 10 is generally uniform along playable section 14 of string 10. As such, string 10 is suitable for use as a musical instrument string 2.

String 10 is generally an elongated single-filament or mono-filament fabricated from plastic 16. For example, a plastic 16 such as nylon may be used to fabricate string 10. Of course, this is not meant to be limiting, and either a single plastic or multiple plastics may be utilized in fabricating string 10. Further, string 10 may be comprised of one or more plastics, and one or more other materials. However, in one preferred embodiment, a single homogeneous nylon is used and includes first and second ends 12, and 13, respectively, and a playable section 14 disposed therebetween. First and second ends 12, and 13, respectively, are fastened or otherwise affixed to supports on a musical instrument (i.e., through eyelets, tying, and the like—not shown), and playable section 14 is disposed therebetween in a manner that depends on the musical instrument being used, and is known in the art.

The specific configurations and features of string 10 may vary according to specific requirements. In the preferred embodiment, string 10 is generally an elongated musical string and is fabricated by extruding nylon into a single filament as is known in the art. Although one preferred embodiment of string 10 is fabricated from nylon utilizing extrusion techniques, other plastic materials and fabrication techniques may be used. As such, this is not meant to be limiting in any manner.

Metallic particles 20 are generally small particles of metal that are disposed within string 10. For example, metal particles on the order of one-billionth of a meter (nanometer) may be used within the one or more plastics 16 of which string 10 is at least partially fabricated from. In one preferred embodiment, metallic particles 20, in the form of a powdered tungsten metal wherein the particles have an average size of one-billionth of a meter, are disposed uniformly throughout plastic 16, which itself comprises a nylon material. However, numerous other metals, either singularly or in mixtures, may be used and include gold, lead, platinum, silver, tantalum, copper, iron, and nickel. These metals are suggested because of their high specific gravities, and their ability to produce the desired characteristics of the particular music string to be manufactured, and in the case of iron and nickel, their electromagnetic properties. However, other metals may be useful as the specific requirements dictate. Of course, these are merely examples and any metal may be utilized, comprising any shape and size small enough to be disposed within the confines of the diameter of string 10, as long as the tonal requirements of the user are met. For example, metallic particles 20 may be fabricated into any shape, whether a metal flake, powder, sphere, cubit, or the like. Further yet, one or more differing metals may be utilized to fabricate metallic particles 20, and if more than one type is used, the one may be of the same or different shape and size particles than the other. As briefly described above, and reiterated for clarity, when musical strings 2 are used with magnetic electrical sensors, for example electric guitars, metallic particles 20 may be fabricated to include particles which are designed to interact with the electromagnetic pickups to either increase or decrease the electromagnetic sensing as the particular requirements dictate. For example, iron and nickel.

The composition, number of plastics and metals utilized, and exact ratio of metallic particles to plastic(s) is variable according to the specific tonal qualities and user requirements. Although not wishing to be bound by theory, as an example, a base “E” string for a classical guitar will typically have a mass per unit length of approximately 0.0626 g/cm (grams per centimeter), and a specific gravity of about 6.1007 g/cc (grams per cubic centimeter). In order to provide the same specific gravity using the inventive string disclosed herein, tungsten of specific gravity 19.3 could be combined with Nylon 6 having specific gravity 1.14 in an amount of 27.32% tungsten by volume. As such, a non-wound (plastic/metal particle) string can be developed having the same or substantially the same mass per unit length. Further, it is envisioned that multiple strings may be fabricated having the same diameter but utilizing differing ratios and/or materials in order to fabricate a set of string having the same diameter but differing notes. To whit, a complete set of strings on, for example a guitar, may be fabricated such that all 6 strings (EADGBE) have the same diameter. Of course, this is only an example, and not intended to define the exact dimensions or construction and as such, not meant to be limiting in any manner.

In another embodiment (FIG. 5), a string for a musical instrument 2A includes an elongated string 10A fabricated at least partially from a plastic 16A. The plastic 16A includes metallic particles 20A, wherein metallic particles 20A are distributed within plastic 16A such that the mass per unit length is generally uniform along a playable section of the string, as described above. However, this embodiment includes a coating or outer layer 30 of a material 32, for example material 32 may be a second plastic. Of course, the two materials may also be similar, or the same, if desired.

In one preferred embodiment, coating 30 includes a uniform coating, wrapping or outer layer of a material, which may be for example the same nylon that is used for plastic 16A. However, coating or wrapping 32 does not include metallic particles 20A. In this manner, the outside surface of musical string 2A is similar in surface appearance to a prior art plastic musical string. Of course, if the requirements dictated, coating 30 could be made to include such metallic particles.

The specific configurations and features of coating 30 may vary according to specific requirements. In the preferred embodiment, coating 30 is generally a uniform plastic coating fabricated by extruding nylon onto a single filament string 10A. Although one preferred embodiment of coating 30 is fabricated from nylon utilizing extrusion techniques, other materials and fabrication techniques may be used. As such, this is not meant to be limiting in any manner. Further, one or more coatings may be utilized and further yet, these one or more coating may each included one or more materials (i.e., plastic or other material) as the particular requirements dictate.

In yet another embodiment, a method of manufacturing a string for a musical instrument comprises: providing one or more plastics; providing a plurality of metallic particles, the plurality of metallic particles comprising one or more metals; blending the one or more plastics and the plurality of metallic particles; forming a single elongated string, whereby the metallic particles are distributed within the one or more plastics such that the mass per unit length is generally uniform along a playable section of the string.

In one preferred embodiment, nylon is combined with a tungsten powder. For example, the plastic and metal products are uniformly combined into pellets for use within an extruding machine. The pellets are then feed into the extruder, wherein the pellets are melted, and possibly further mixed, to then be extruded into a continuous filament having the metallic particles evenly distributed within the nylon filament such that the metallic particles are distributed within the nylon in order to provide a string having a mass per unit length which is generally uniform. The single filament is then fabricated into individual musical strings as is known in the art. Of course this is merely an embodiment and not meant to be limiting in any manner. The particular fabrication techniques for the described process are all known in the art.

In addition to the primary benefit of avoiding unpleasant squeaking, the invention has additional benefits, which include: 1) allowing the adjustment of string diameter for playing comfort rather than strictly for pitch and tension; 2) reducing intonation error caused by rigid strings; 3) avoiding the fraying of the metal windings in traditional strings; and 4) avoiding string breaks along the bridge such as in wound guitar strings which do not have sufficient core strength.

Advantageously, the musical string of the present invention is simple and the raw materials may be comprised of a plastic, such as nylon, and high specific gravity particles, such as tungsten, admixed therein. The musical string is efficiently fabricated while being engineered to be structurally superior to prior art musical strings. Consequently, the embodiments of the preferred invention disclosed herein reveal a musical string which is more robust than existing designs, and eliminates the need for windings on musical strings.

The solutions offered by the invention disclosed herein have thus been attained in an economical, practical, and facile manner. To whit, a novel musical string which eliminates the need for outer windings has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A string for a musical instrument, comprising:
an elongated string having a first and second end, and a playable section disposed therebetween, the string fabricated at least partially from a plastic, the plastic including metallic particles disposed therein;
wherein the metallic particles are distributed within the plastic such that a mass per unit length is generally uniform along the playable section of the string;
wherein the string is suitable for use as a musical instrument string.

2. The string of claim 1, wherein:
the metallic particles are disposed generally uniformly within the plastic.

3. The string of claim 1, wherein:
the string is coated with a plastic outer layer, the plastic outer layer comprising one or more plastics.

4. The string of claim 1, wherein:
the string is fabricated entirely from the plastic;
wherein the metallic particles are disposed generally uniformly within the plastic.

5. The string of claim 1, wherein:
the string is fabricated entirely from nylon.

6. The string of claim 1, wherein:
the metallic particles comprise a powdered metal.

7. The string of claim 1, wherein:
the metallic particles comprise iron.

8. The string of claim 1, wherein:
the metallic particles comprise tungsten.

9. A string for a musical instrument, comprising:
an elongated string having a first and second end, and a playable section disposed therebetween, the string fabricated entirely from a plastic, the plastic including metallic particles disposed generally uniformly therein;
wherein the metallic particles are distributed within the plastic such that a mass per unit length is generally uniform along the playable section of the string;
wherein the string is suitable for use as a musical instrument string.

10. The string of claim 9, wherein:
the string is coated with a plastic outer layer, the plastic outer layer comprising one or more plastics.

11. The string of claim 9, wherein:
the string is fabricated entirely from nylon.

12. The string of claim 9, wherein:
the metallic particles comprise a powdered metal.

13. The string of claim 9, wherein:
the metallic particles comprise iron.

14. The string of claim 9, wherein:
the metallic particles comprise tungsten.

15. A method of manufacturing a string for a musical instrument, comprising:
providing one or more plastics;
providing a plurality of metallic particles, the plurality of metallic particles comprising one or more metals;
blending the one or more plastics and the plurality of metallic particles;
forming a single elongated string;
whereby the metallic particles are distributed within the one or more plastics such that a mass per unit length is generally uniform along a playable section of the string.

16. The method of claim 15, wherein:
disposing the metallic particles generally uniformly within the one or more plastics.

17. The method of claim 15, wherein the method further includes:
coating the string with a plastic outer layer, the plastic outer layer comprising one or more second plastics.

18. The method of claim 15, wherein:
the metallic particles comprise a powdered metal.

19. The method of claim 15, wherein:
the metallic particles comprise iron.

20. The method of claim 15, wherein:
the metallic particles comprise tungsten.
